(19) United States
(12) Patent Application Publication
(10) Pub. No.: US 2009/0181733 A1
(43) Pub. Date: Jul. 16, 2009

(54) PORTABLE COMMUNICATION DEVICE HAVING A MULTI-AXIS HINGE ASSEMBLY

(75) Inventor: Randolph C. Demuycnk, Wake Forest, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/014,345

(22) Filed: Jan. 15, 2008

(51) Int. Cl. H04M 1/00

(52) U.S. Cl. 455/575.3

(57) ABSTRACT

A mobile phone that includes a base and display coupled to the base by a hinge assembly, and the hinge assembly is configured to provide sliding motion between the base and the display along a first axis and rotational motion about the first axis between the base and the display.

### TECHNICAL FIELD OF THE INVENTION

The present invention relates generally to portable communication devices, and more particularly, to a portable communication device having a multi-axis hinge assembly.

### DESCRIPTION OF THE RELATED ART

Mobile communication devices, including smart phones and personal communication devices or personal digital assistants (PDAs), are used to place phone calls as well as to compose, send, and receive text messages, emails, and/or other text documents. Text can be entered into these devices in several different ways, including a numerical keypad in which each number on the keypad corresponds to several letters of the alphabet or a full keyboard, for example, a QWERTY keypad. Numerical keypads sometimes are cumbersome and difficult to use because each number corresponds to several letters and, therefore, the keypad is inefficient for entering text. In mobile devices equipped with a QWERTY keypad, each key typically corresponds to a single letter. Given the relatively small size of mobile devices, however, the keys of a QWERTY keypad tend to be small and often difficult to identify and press.

### SUMMARY

To enhance functionality and versatility, a mobile phone is provided with a multi-axis hinge assembly that facilitates sliding motion along a first axis and rotational motion about the first axis between a display portion and a base portion of the mobile phone.

One aspect of the disclosed technology relates to a portable communication device that includes a base portion and a display portion coupled to the base portion by a hinge assembly, wherein the hinge assembly is configured to provide sliding motion between the base portion and the display portion along a first axis and rotational motion about the first axis between the base portion and the display portion.

According to another aspect, the hinge assembly includes a rail coupled to one of the base portion or the display portion, and a hinge coupled to the other of the base or the display, wherein the hinge portion is slidably coupled to the rail portion.

According to another aspect, the rail defines a slot and the hinge includes an engagement member slidable within the slot.

According to another aspect, the portable communication device further comprises a first keypad and a second keypad, wherein the display portion is configured to slide relative to the base portion, and the sliding exposes the first keypad.

According to another aspect, the display portion is configured to rotate relative to the base portion, and the rotation exposes the second keypad.

According to another aspect, the first keypad is a numerical keypad and the second keypad is a QWERTY keypad.

According to another aspect, the portable communication device is a mobile phone.

Another aspect of the disclosed technology relates to a hinge assembly configured to connect a first member and a second member of a portable communication device. The hinge assembly includes a track on one of the first member or the second member; and a hinge slidably coupled to the track, wherein the track and hinge cooperate to provide sliding motion and rotational motion between the first and second members of the portable communication device.

According to another aspect, the sliding motion and the rotational motion are along and about the same axis, respectively.

According to another aspect, the portable communication device is a mobile phone, and wherein the first member is a base and the second member is a display.

According to another aspect, the track defines a slot and the hinge includes an engagement member slidable within the slot.

Another aspect of the disclosed technology relates to a portable communication that includes a housing having a base portion and a display portion operatively coupled to the base portion by a hinge assembly, wherein the hinge assembly is configured to provide sliding motion and rotational motion between the display portion and the base portion.

According to another aspect, the sliding motion is along a first axis and the rotational motion is about the first axis.

According to another aspect, the portable communication device is configurable into a first configuration by sliding the display relative to the base.

According to another aspect, the portable communication device is configurable into a second configuration by rotating the display relative to the base.

According to another aspect, the portable communication device further comprises a first keypad and a second keypad, wherein a portion of the first keypad is exposed when the portable communication device is in the first configuration.

According to another aspect, a portion of the second keypad is exposed when the portable communication device is in the second configuration.

According to another aspect, the first keypad is a numerical keypad and the second keypad is a QWERTY keypad.

According to another aspect, the hinge assembly includes a track on a side portion of the base portion and a hinge on a side portion of the display portion, wherein the track defines a slot configured to slidably receive an engagement member of the hinge.

According to another aspect, the portable communication device is a mobile phone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a top view of a mobile telephone in a closed position as an exemplary portable communication device;

FIG. 2 is a top view of the mobile telephone of FIG. 1 slid open to expose a numerical keypad;

FIG. 3 is a front view of the mobile telephone of FIG. 1 rotated to an open position to expose a full keypad;

FIG. 4 is a top view of the mobile telephone of FIG. 3;

FIG. 5 is a sectional view of an embodiment of the mobile phone of FIG. 1 with the display rotated to an open position to expose a full keypad;

FIG. 6 is a sectional view of an embodiment of the mobile phone of FIG. 1 with the display closed;

FIG. 7 is a rear perspective view of the mobile phone of FIG. 1 in a closed configuration;

FIG. 8 is a rear perspective view of the mobile phone of FIG. 1 in an open configuration; and

FIG. 9 is a sectional view of another embodiment of the mobile phone of FIG. 1 with the display closed.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Many mobile communication devices have a limited surface area that can be used for a display screen, functional keys and a keypad. As mobile communication devices become smaller and thinner in size, the surface area available for the screen and keys is reduced. To maximize the screen size, some mobile devices have incorporated the keys onto a separate surface, such as the base. The display of these mobile devices is movable with respect to the base when the keypad is accessed. Known mobile devices of these varieties include clamshell devices, in which the display is connected to the base via a conventional hinge, and slider devices, in which the display is slidable with respect to the base, for example, on a rail or a track.

Hinged devices include a hinge connecting the base to the display. The device may be flipped open vertically (e.g., portrait orientation) or horizontally (e.g., landscape orientation) to display the keypad. The keypad in these devices generally is a dual function keypad that operates as a full keypad with an overlapping numerical pad (e.g. several letters on the keyboard also correspond to numbers). Relative to the rest of the device, the dual hinge required for to operate in portrait and landscape orientations occupies a significant amount of space on the base. Consequently, the keys on the keypad typically are small and, therefore, they are rather difficult to use.

Slider devices may have a keypad on the base that is exposed by sliding the display vertically and/or horizontally with respect to the base. The display typically overlaps at least a portion of the base in order to keep the slider in the channel and the display attached to the base. As a result, the space available for the keyboard for slider phones is somewhat limited and the keyboard, therefore, must be limited in size, making it relatively difficult to use.

The present disclosure recognizes shortcomings with conventional clamshell devices and hinged devices, as well as potential shortcomings with keypad size and position on a portable communication device. The present disclosure provides a portable communication device (e.g., a mobile phone) having a multi-axis hinge assembly coupling a mobile phone base portion and display portion. The multi-axis hinge assembly is configured to provide sliding motion between the base portion and the display portion along a first axis and rotational motion between the base portion and the hinge portion about the first axis. As is described more fully below, the provision of a multi-axis hinge assembly allows the portable communication device to be operated as a slider-type device in a first configuration and as a clamshell-type device in a second configuration.

As referred to herein, the term “portable communication device” includes portable radio communication equipment. The term “portable radio communication equipment,” which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While discussed with respect to portable communication devices, it is to be appreciated that the invention is not intended to be limited to portable communication devices, and can be applied to any type of handheld mobile electronic equipment equipped with a multi-axis hinge assembly.

In the present application, the invention is described primarily in the context of a mobile telephone. It will be appreciated, however, that the invention is not intended to be limited to a mobile telephone and can be any type of electronic equipment.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

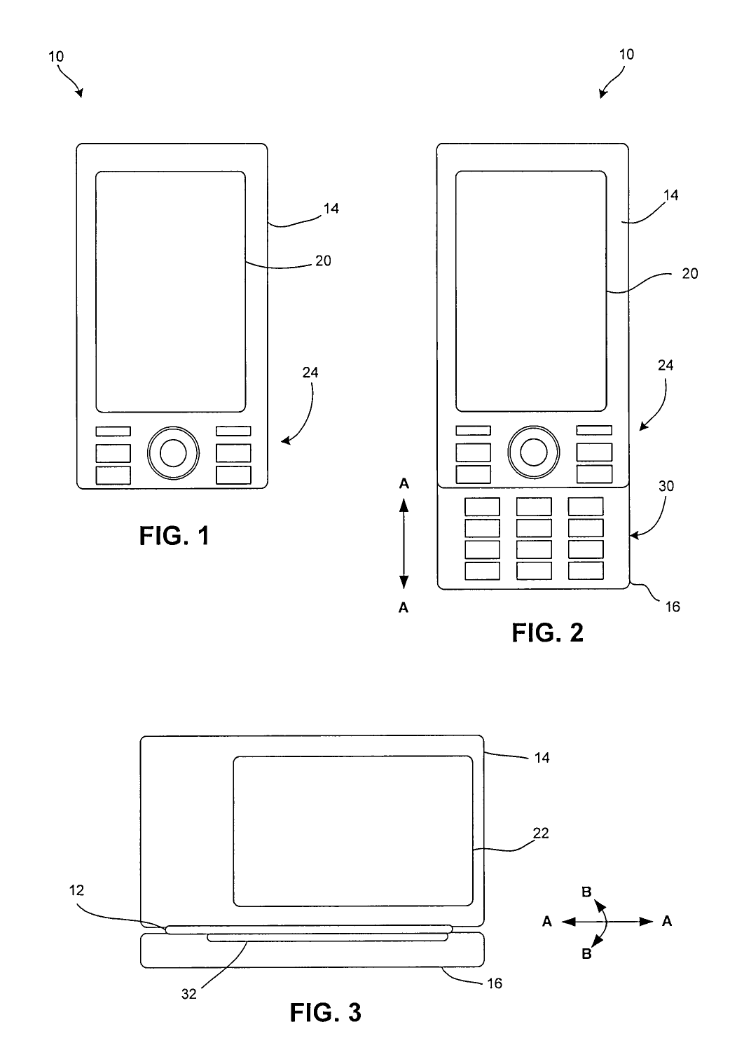

Referring initially to FIGS. 1-4, an exemplary embodiment of a portable communication device 10 (e.g., a mobile phone, mobile terminal or the like) is depicted. As is described more fully below, the portable communication device 10 includes a multi-axis hinge assembly 12 (also referred to simply as a hinge assembly, a rail hinge assembly or a mini rail hinge assembly) that provides or otherwise facilitates movement between the phone display 14 (also referred to as the display portion or display housing portion) and the base 16 (also referred to as the base portion or the base housing portion) with at least two degrees of freedom (e.g., sliding movement along a first axis and rotational movement about the first axis). In the illustrated exemplary embodiment, the mobile phone 10, therefore, can be slid open to operate in portrait orientation or flipped open to operate in landscape orientation. Due to the relatively small size of the hinge assembly 12, a large portion of the base 16 can be used for or otherwise house a full keypad 32 (e.g., a QWERTY keypad), allowing the keys to be larger than in conventional mobile devices and generally making the keypad easier to use.

The portable communication device 10 in the illustrated embodiments is a mobile telephone, and may be referred to as the mobile phone 10. As indicated, the description and illustrations of a mobile telephone are intended to serve as a non-limiting exemplary environment for the inventive concepts described herein.

In one embodiment, the mobile telephone 10 is configured as a dual-display device having a first display screen 20 (e.g., an outer display screen) and a second display screen 22 (e.g., an inner display screen). The first and second display screens 20, 22 may display information to a user, such as operating state, time, telephone numbers, contact information, menus, etc., which enable a user to utilize various features of the mobile telephone 10. The first display screen 20 and the second display screen 22 also may be used to visually display content received by the mobile telephone 10 and/or retrieved from a memory of the mobile telephone 10. In one embodiment, the first display screen 20 and the second display screen 22 may be 2.4″ thin film transistor (TFT) screens that are approximately 2.4 inches to 2.6 inches wide and approximately 2 mm thick. It will be appreciated that larger or smaller screens (as well as screens having different sizes or dimensions) may be utilized without departing from the scope of the present invention.

In the illustrated embodiment, the mobile phone 10 includes a set of functional keys 24 that provide for a variety of user input operations. For example, the functional keys 24 typically include special function keys, such as a “call send” key for initiating or answering a call, and a “call end” key for ending or “hanging up” a call. Special function keys also may include menu navigation keys, for example, for navigating through a menu displayed on the display(s) to select different telephone functions, profiles, settings, etc., as is conventional. Other navigational keys or controls may include directional keys (e.g., up, down, left, and right) to highlight different links, or icons, or to navigate text or other documents etc. The navigational controls also may be in the form of a roller ball or navigational ball, as will be appreciated. Additionally, the displays 20, 22 also may be navigated by using a stylus or by otherwise touching the surface of the display(s). Other keys associated with the mobile telephone may include a volume key, an audio mute key, an on/off power key, a web browser launch key, a camera key and the like. Keys or key-like functionality also may be embodied as a touch screen on the display screen(s) without departing from the scope of the present invention.

The mobile telephone 10 includes conventional call circuitry that enables the mobile telephone 10 to establish a call or otherwise exchange signals with a call/calling device, typically another mobile telephone, landline telephone or other electronic device. The call/calling device, however, need not be another telephone, but may be some other device, such as an Internet web server, media server or the like. The call circuitry also may be responsible for transmitting text messages, emails, or text documents that are prepared by the user.

In a preferred embodiment, the mobile phone 10 includes a first keypad 30 (e.g., a numeric keypad) and a second keypad 32 (e.g., a QWERTY keypad). As is discussed more fully below, the mobile phone may be operated in a first configuration, for example, by sliding the display portion 14 relative to the base portion 16 to access the first keypad 30. Also, the mobile phone may be operated in a second configuration, for example, by rotating or otherwise flipping open the display portion 14 relative to the base portion 16 to access the second keypad 32.

The mobile phone 10 is configured to operate in both portrait (FIG. 2) and landscape (FIG. 3) orientations. The display portion 14 is slidably and rotatably coupled to the base 16 by a multi-axis hinge assembly 12 (e.g., a mini rail hinge assembly). In a first configuration, the display portion 14 is slidable along a first axis (as indicated by the arrow A) with respect to the base portion 16 to expose the first keypad, (e.g., a numeric keypad) having a set of alphanumeric keys, such as those included on a conventional telephone dial pad. When the keypad 30 is used in conjunction with the functional keys 24, a telephone call, email or text message, etc. can be composed and sent from the phone 10. In this configuration, the user may view displayed items on the first display 20.

In a second configuration, the display portion 14 is rotatable about the first axis (as indicated by arrow B) with respect to the base portion 16 to open the phone and expose a full keypad 32, for example, a QWERTY keypad. The keypad 32 can be used to enter text, which is displayed on the second display screen 24, and can be used to create, edit and/or send emails, text messages, text documents, or other files, etc.

The multi-axis hinge assembly 12, therefore, allows the mobile phone 10 to operate as a slider phone (FIG. 2) and a clamshell phone (FIG. 3), with each phone configuration having a separate keypad and separate display. Due in part to the relatively small size of the mini rail hinge 12, and the combined slider-clamshell configuration, a large portion of the surface area of the base portion 16 can be used for keypad 32, allowing the keys to be larger and facilitating the entry of text, and which also may allow the mobile phone 10 to be smaller and thinner.

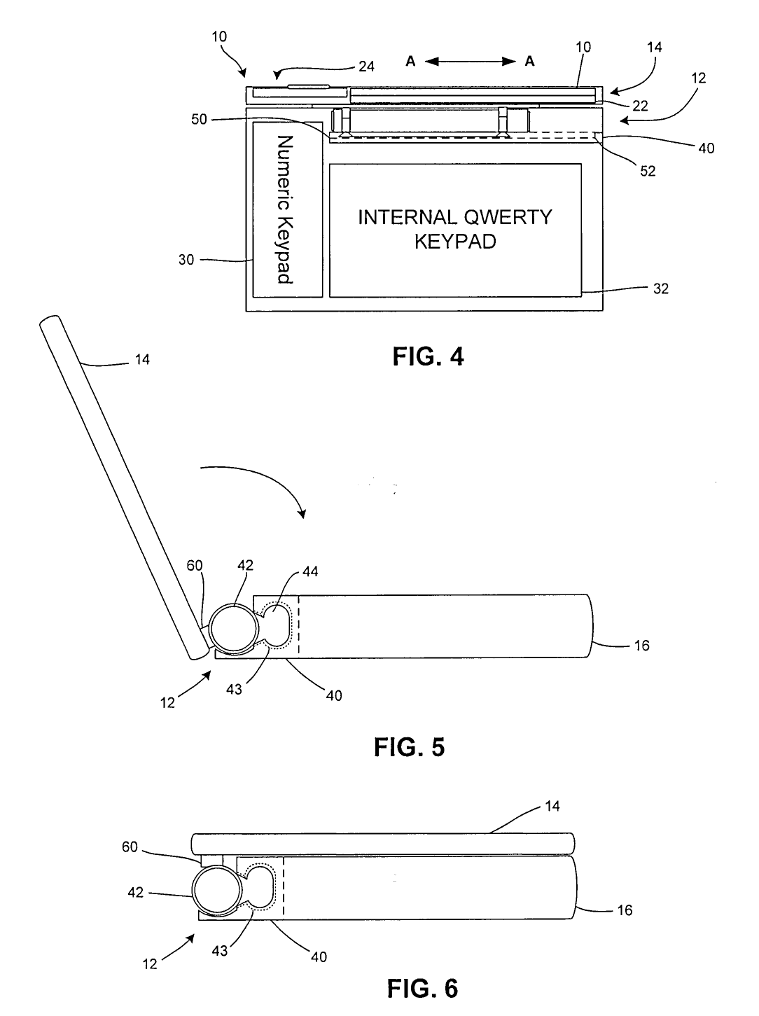

Referring now to FIG. 4, a top view of the exemplary mobile telephone 10 in an open configuration is provided. As with the mobile telephone of FIG. 3, the display portion 14 is rotated to an open position. The base portion 16 includes a numeric keypad 30 and a QWERTY keypad 32.

The hinge assembly 12 connects the display portion 14 to the base portion 16 and provides two degrees of freedom, (e.g., movement along a first axis and rotation about the first axis) between the display portion 14 and the base portion 16. The hinge assembly 12 includes a rail or track 40, which, in one embodiment, is mounted to, coupled to, or otherwise formed integrally with the base portion 16. Alternatively, the rail or track 40 may be mounted to, coupled to or otherwise formed integrally with the display portion 14. The rail 40 includes or otherwise defines a slot 43. A hinge 42 (e.g., a spring hinge or other resilient hinge) is coupled to the rail 40 by a sliding engagement member 44 (also referred to as a slider or simply as an engagement member). The engagement member 44 is configured to slidably engage the rail within the slot 43 to allow the hinge 42 to slide along the track 40. Stated differently, the sliding engagement member is cooperative with and slidable within the rail or track. As shown in FIGS. 5-8, the track 40 guides the sliding engagement member 44 of the hinge 42 along a trajectory generally defined by arrows A (FIG. 2 and FIG. 4) such that the display portion 42 may be slid open to access the numeric keypad 30.

In one embodiment, the track 40 includes a first edge 50 and a second edge 52 that act as upper and lower limits on the movement of the slider 44 in the track 40. When the mobile telephone 10 is in the closed position and the numeric keypad 30 is hidden from the user (FIG. 1), the slider 44 is limited from sliding in the track 40 by the first edge 50. When the display portion 14 is slid or otherwise moved to allow access to the numeric keypad 30, the slider 44 slides in or along the slot 43 in track 40 until it reaches the second edge 52. The second edge 52 further limits movement of the slider 44 and the display portion 14, and also prevents the slider 44 from sliding out of the track 40. In a preferred embodiment, the first edge 50 and second edge 52 are spaced from each other such that the numeric keypad 30 is fully exposed when the slider 44 is slid from the first edge 50 to the second edge 52.

In one embodiment, a display mount 60 is fixedly attached to or integrally formed with the display portion 14 and connected to the hinge 40 of the hinge assembly 12. The sliders 44 also may be fixedly attached or molded to the hinge 40 of the hinge assembly 12 via slider mounts or another suitable mechanism. As will be discussed in more detail below, the sliders 44 are configured such that they are slidable, but not rotatable, with respect to the base portion 16. Thus, the display portion 14 and display mount 60 rotate relative to the sliders 44 and the base portion 16 via the hinge 40 to open and close the phone 10.

One embodiment of the slider/track configuration is shown in FIGS. 5-8. The slider 44 includes a wide portion and a narrow portion that correspond to a wide portion and narrow portion or neck, respectively, of the track 40. In this embodiment, the wider portion of the slider 44 nests or fits within the wider portion of the track 40. Likewise, the narrower portion of the slider nests with or fits within the neck of the track. The neck impedes removal of the slider from the track in part by limiting the movement of the wider portion of the slider. As such, the slider 44 is prevented from rotating relative to the base portion 16. It will be appreciated that the above describes one suitable geometry for the multi-axis hinge assembly. Other geometries may be employed depending upon the size and desired functionality of the mobile phone without departing from the scope of the present invention.

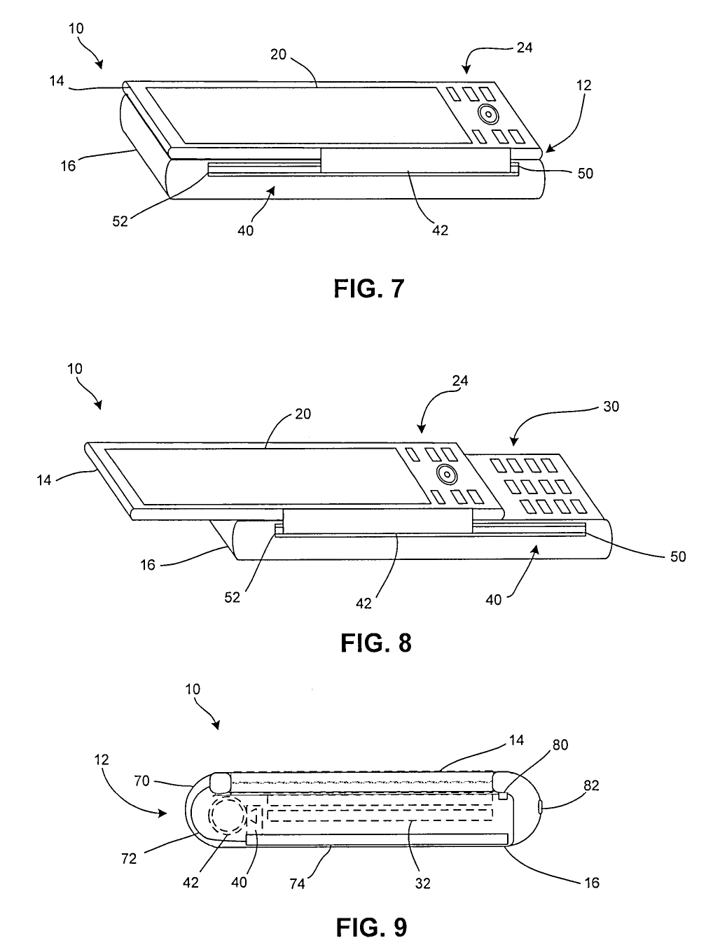

Preferably, the slider 44 and track 40 are composed of relatively smooth, low friction materials to reduce the likelihood that the slider 44 will bind or twist in the track 40 when the display portion 14 is slid relative to the base portion 16. Suitable materials include plastics, metals, composite materials and the like, as will be appreciated by one of skill in the art. As shown in the figures, the track 40 may be molded or integrated with the base portion 16. Although the track 40 is shown as a female channel molded onto the base and male slider, it also will be appreciated that the track may be integrated with the hinge assembly as a female channel and the slider may be an extension of the base portion that fits within the track. Regardless of whether the female channel is integrated with the base portion or the hinge assembly, the operation of the mobile phone 10, and in particular the two degrees of freedom (e.g., motion along a first axis and rotational motion about the first axis) between the display portion 14 and base portion, are the same. It also will be appreciated that two or more sliders may be used in a similar fashion, or the slider may be a single, elongate slider that fits in the channel and operates as described above (see FIGS. 7 and 8, for example).

While the illustrated sliders 44 and track 40 are generally keyhole shaped, it will be appreciated that any of a variety of different configurations may be suitable to facilitate the sliding of the display portion 14 relative to the base portion 16, without rotating the sliders 44 relative to the base portion.

A sectional view of another embodiment of the mobile phone 10 is shown in FIG. 9. A shell or other housing member 70 encases or otherwise surrounds or partially surrounds the hinge assembly 12 and protects one or more flex circuits 72 from damage and/or from possible exposure to the environment. The flex circuits 72 electrically couple the display portion 14 (e.g., the first screen 20 and the second screen 22) to a printed circuit board assembly (PCBA) 74 or other control circuitry, which controls the functionality of the mobile phone 10. The cavity created by the hinge assembly 12 provides access for the flex circuit 72 to be routed through the hinge assembly 12 for connection to the display portion and other associated flip peripherals or components that may be incorporated into the mobile phone.

As described above, the hinge assembly 12 allows the display portion 14 to move with respect to the base portion 16 with at least two degrees of freedom (e.g., longitudinal movement and rotational movement). The numeric keypad 30 is exposed by sliding the display portion 14 with respect to the base portion 16 via the slider 44 and track 40 of the hinge assembly 12. The mobile phone 10 also may include guide 80 extending generally along the length of the mobile phone 10. The guide 80 facilitates the movement of the display portion 14 with respect to the base portion 16 and limits or reduces the likelihood that the slider 44 will bind or twist in the track 40 when the display portion 14 is slid open. The guide 80 also may operate to inhibit the rotational motion of the display portion 14 relative to the base portion 16 when the display 10 is slid open.

The mobile phone 10 may include flip release 82 or other releasable engagement mechanism for maintaining the mobile phone 10 in a closed position. The release 82 may, for example, lock or prevent the display from accidentally rotating open when the mobile phone 10 is slid to access the numeric keypad 30. The flip release 82 also may be integrated with or coupled to the guide 80 to achieve the same purpose.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A portable communication device comprising:
a base portion; and
a display portion coupled to the base portion by a hinge assembly, wherein the hinge assembly is configured to provide sliding motion between the base portion and the display portion along a first axis and rotational motion about the first axis between the base portion and the display portion.

2. The portable communication device of claim 1, wherein the hinge assembly comprises:
a rail coupled to one of the base portion or the display portion; and
a hinge coupled to the other of the base or the display, wherein the hinge portion is slidably coupled to the rail portion.

3. The portable communication device of claim 2, wherein the rail defines a slot and the hinge includes an engagement member slidable within the slot.

4. The portable communication device of claim 1, further comprising a first keypad and a second keypad, wherein the display portion is configured to slide relative to the base portion, and the sliding exposes the first keypad.

5. The portable communication device of claim 2, wherein the display portion is configured to rotate relative to the base portion, and the rotation exposes the second keypad.

6. The portable communication device of claim 5, wherein the first keypad is a numerical keypad and the second keypad is a QWERTY keypad.

7. The portable communication device of claim 1, wherein the portable communication device is a mobile phone.

8. A hinge assembly configured to connect a first member and a second member of a portable communication device, the hinge assembly comprising:
a track on one of the first member or the second member; and
a hinge slidably coupled to the track, wherein the track and hinge cooperate to provide sliding motion and rotational motion between the first and second members of the portable communication device.

9. The hinge of claim 8, wherein the sliding motion and the rotational motion are along and about the same axis, respectively.

10. The hinge assembly of claim 8, wherein the portable communication device is a mobile phone, and wherein the first member is a base and the second member is a display.

11. The hinge assembly of claim 8, wherein the track defines a slot and the hinge includes an engagement member slidable within the slot.

12. A portable communication device comprising:
a housing having a base portion and a display portion operatively coupled to the base portion by a hinge assembly, wherein the hinge assembly is configured to provide sliding motion and rotational motion between the display portion and the base portion.

13. The portable communication device of claim 12, wherein the sliding motion is along a first axis and the rotational motion is about the first axis.

14. The portable communication device of claim 12, wherein the portable communication device is configurable into a first configuration by sliding the display relative to the base.

15. The portable communication device of claim 13, wherein the portable communication device is configurable into a second configuration by rotating the display relative to the base.

16. The portable communication device of claim 15, further comprising a first keypad and a second keypad, wherein a portion of the first keypad is exposed when the portable communication device is in the first configuration.

17. The portable communication device of claim 16, wherein a portion of the second keypad is exposed when the portable communication device is in the second configuration.

18. The portable communication device of claim 17, wherein the first keypad is a numerical keypad and the second keypad is a QWERTY keypad.

19. The portable communication device of claim 12, wherein the hinge assembly includes a track on a side portion of the base portion and a hinge on a side portion of the display portion, wherein the track defines a slot configured to slidably receive an engagement member of the hinge.

20. The portable communication device of claim 12, wherein the portable communication device is a mobile phone.
